(19) United States
(12) Patent Application Publication
(10) Pub. No.: US 2021/0364865 A1
(43) Pub. Date: Nov. 25, 2021

(54) PIXEL ELECTRODE STRUCTURE AND LIQUID CRYSTAL DISPLAY PANEL

(71) Applicant: SHENZHEN CHINA STAR OPTOELECTRONICS SEMICONDUCTOR DISPLAY TECHNOLOGY CO., LTD., Shenzhen (CN)

(72) Inventor: Wu CAO, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 16/625,783

(22) PCT Filed: Dec. 16, 2019
(86) PCT No.: PCT/CN2019/125555

§ 371 Date: Dec. 23, 2019

(30) Foreign Application Priority Data
Dec. 4, 2019 (CN) 201911223940.6

(51) Int. Cl. G02F 1/1337; G02F 1/1343

(52) U.S. Cl. CPC G02F 1/133707; G02F 2201/122; G02F 1/134327

(57) ABSTRACT

The disclosure provides a pixel electrode structure and a liquid crystal display (LCD) panel. The pixel electrode structure includes a main electrode, a plurality of branch electrodes, and a plurality of gaps. The main electrode is a strip electrode with a zigzag shape. A junction electric field is formed in a liquid crystal cell to which the main electrode corresponds, which may improve convergence and collimation of light and increase light transmittance through a display panel. Furthermore, a width of the main electrode is reduced, which further reduces widths of black lines appearing on a location corresponding to the main electrode and further increases light transmittance of the display panel.

### FIELD

The present disclosure relates to the field of display and, more particularly, relates to a pixel electrode structure and a liquid crystal display panel.

### BACKGROUND

Typically, a pixel electrode of conventional liquid crystal displays (LCDs) has a multi-domain structure. As shown in FIG. 1, FIG. 1 is a schematic plan view showing a conventional pixel electrode structure. A pixel electrode 10 includes a main electrode 101 and a main electrode 102 which are located on a center of a pixel electrode and cross each other, a plurality of branch electrodes 103 connected to the above main electrodes, and a plurality of gaps formed between the branch electrodes 103. The main electrode 101 and the main electrode 102 are straight lines, and the branch electrodes 103 are symmetrically disposed with respect to the above two main electrodes.

As shown in FIG. 8(a), FIG. 8(a) is a simulation diagram showing a conventional pixel electrode. Because of the continuum property of liquid crystals, an improvement of viewing angles by the multi-domain structure is accompanied by black lines naturally appearing on a location corresponding to a main electrode. To ensure stability of the black lines, a width of the main electrode typically ranges from 4 μm to 8 μm during an ultraviolet vertical alignment process, resulting in the black lines with widths of 3 μm to 6 μm, which reduces light transmittance through a display panel.

Consequently, a problem of low light transmittance through conventional LCD panels needs to be solved.

### SUMMARY

The present disclosure provides a pixel electrode structure and an LCD to alleviate a problem of low light transmittance through conventional LCD panels.

To solve the above problem, technical solutions provided by the present disclosure are described below.

The present disclosure provides a pixel electrode structure, including: a main electrode located on a center of a pixel electrode, wherein the pixel electrode is divided into at least two liquid crystal alignment regions by the main electrode, and the main electrode is an electrode strip with a zigzag shape; a plurality of branch electrodes located in each of the at least two liquid crystal alignment regions, wherein the branch electrodes are parallel to each other and are connected to the main electrode; and a plurality of gaps formed between every two adjacent branch electrodes.

In the pixel electrode structure provided by the present disclosure, a width of the main electrode ranges from 2 μm to 6 μm.

In the pixel electrode structure provided by the present disclosure, widths of the branch electrodes range from 2 μm to 3.5 μm.

In the pixel electrode structure provided by the present disclosure, the main electrode is made of a plurality of main electrode segments which are connected to each other, and an included angle between each two adjacent main electrode segments ranges from 60° to 120°.

In the pixel electrode structure provided by the present disclosure, an included angle between the branch electrodes and the main electrode connected thereto and the included angle between each two adjacent main electrode segments are same.

In the pixel electrode structure provided by the present disclosure, the included angle between each two adjacent main electrode segments is 90°.

In the pixel electrode structure provided by the present disclosure, widths of the main electrode segments are same.

In the pixel electrode structure provided by the present disclosure, each of the main electrode segments corresponds to one of the gaps.

In the pixel electrode structure provided by the present disclosure, each of the main electrode segments corresponds to and is perpendicular to two of the gaps.

In the pixel electrode structure provided by the present disclosure, each of the main electrode segments corresponds to and is perpendicular to three of the gaps.

Furthermore, the present disclosure provides an LCD panel, including a pixel electrode structure including: a main electrode located on a center of a pixel electrode, wherein the pixel electrode is divided into at least two liquid crystal alignment regions by the main electrode, and the main electrode is an electrode strip with a zigzag shape; a plurality of branch electrodes located in each of the at least two liquid crystal alignment regions, wherein the branch electrodes are parallel to each other and are connected to the main electrode; and a plurality of gaps formed between every two adjacent branch electrodes.

In the LCD panel provided by the present disclosure, a width of the main electrode ranges from 2 μm to 6 μm.

In the LCD panel provided by the present disclosure, a width of the main electrode ranges from 2 μm to 6 μm.

In the LCD panel provided by the present disclosure, the main electrode is made of a plurality of main electrode segments which are connected to each other, and an included angle between each two adjacent main electrode segments ranges from 60° to 120°.

In the LCD panel provided by the present disclosure, an included angle between the branch electrodes and the main electrode segments connected thereto and the included angle between each two adjacent main electrode segments are same.

In the LCD panel provided by the present disclosure, the included angle between each two adjacent main electrode segments is 90°.

In the LCD panel provided by the present disclosure, widths of the main electrode segments are same.

In the LCD panel provided by the present disclosure, each of the main electrode segments corresponds to one of the gaps.

In the LCD panel provided by the present disclosure, each of the main electrode segments corresponds to and is perpendicular to two of the gaps.

In the LCD panel provided by the present disclosure, each of the main electrode segments corresponds to and is perpendicular to three of the gaps.

Regarding the beneficial effects: the present disclosure provides a pixel electrode structure and an LCD panel. The pixel electrode structure includes a main electrode located on a center of a pixel electrode, wherein the pixel electrode is divided into at least two liquid crystal alignment regions by the main electrode, and the main electrode is an electrode strip with a zigzag shape; a plurality of branch electrodes located in the at least two liquid crystal alignment regions, wherein the branch electrodes are parallel to each other and are connected to the main electrode; and a plurality of gaps formed between two adjacent branch electrodes. By the zigzag-shaped electrode strip of the pixel electrode structure, a junction electric field is formed in a liquid crystal cell to which the main electrode corresponds. The junction electric field may improve convergence and collimation of light; therefore, black lines may be stabilized, widths of the black lines may be reduced, and light transmittance through display panels may be increased. Furthermore, by a disposing way of the zigzag-shaped electrode strip, black lines may be stabilized, and widths of the main electrode may be reduced, thereby further reducing widths of the black lines appearing on a location corresponding to the main electrode and increasing light transmittance through display panels.

### DESCRIPTION OF DRAWINGS

FIG. 1 is a schematic plan view showing a conventional pixel electrode structure.

FIG. 2 is a schematic plan view showing a first pixel electrode structure provided by an embodiment of the present disclosure.

FIG. 3 is a partially enlarged schematic view of the first pixel electrode structure in FIG. 2.

FIG. 4 is a schematic plan view showing a second pixel electrode structure provided by an embodiment of the present disclosure.

FIG. 5 is a partially enlarged schematic view of the second pixel electrode structure in FIG. 4.

FIG. 6 is a schematic plan view showing a third pixel electrode structure provided by an embodiment of the present disclosure.

FIG. 7 is a partially enlarged schematic showing the third pixel electrode structure in FIG. 6.

FIG. 8(a) is a simulation diagram showing a conventional pixel electrode structure.

FIG. 8(b) is a simulation diagram showing the first pixel electrode structure provided by the embodiment of the present disclosure.

FIG. 8(c) is a simulation diagram showing the second pixel electrode structure provided by the embodiment of the present disclosure.

FIG. 8(d) is a simulation diagram showing the third pixel electrode structure provided by the embodiment of the present disclosure.

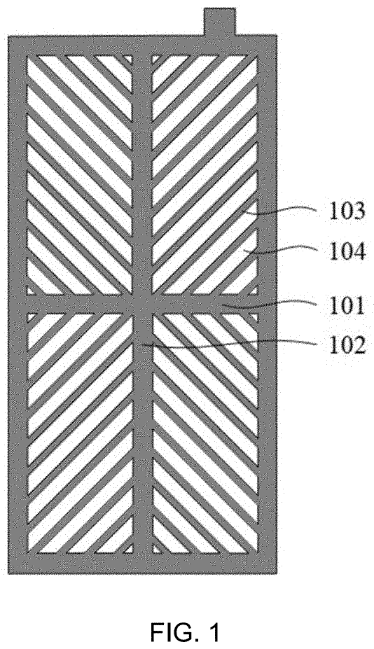

### DETAILED DESCRIPTION

The following description of the various embodiments is provided with reference to the accompanying drawings. It should be understood that terms such as “upper”, “lower”, “front”, “rear”, “left”, “right”, “inside”, “outside”, “lateral”, as well as derivative thereof should be construed to refer to the orientation as then described or as shown in the drawings under discussion. These relative terms are for convenience of description, do not require that the present disclosure be constructed or operated in a particular orientation, and shall not be construed as causing limitations to the present disclosure. In the drawings, the identical or similar reference numerals constantly denote the identical or similar elements or elements having the identical or similar functions.

A pixel electrode structure provided by the present disclosure may alleviate a problem of low light transmittance through conventional LCD panels.

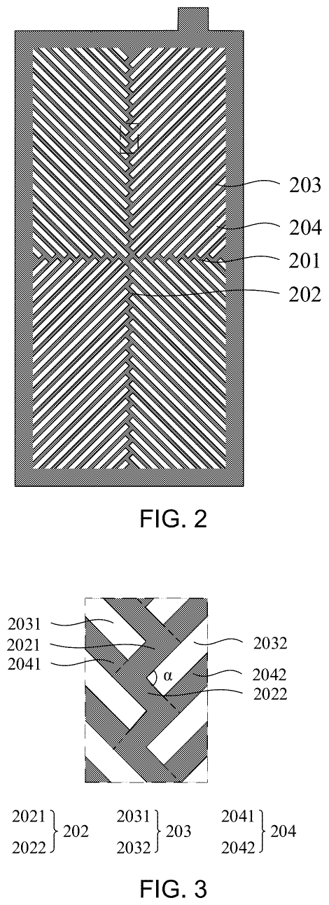

In one embodiment, as shown in FIG. 2 to FIG. 7, FIG. 2 to FIG. 7 are schematic plan views of a pixel electrode structure provided by the embodiment of the present disclosure. The pixel electrode structure includes: a main electrode located on a center of a pixel electrode, wherein the pixel electrode is divided into at least two liquid crystal alignment regions by the main electrode, and the main electrode is an electrode strip with a zigzag shape; a plurality of branch electrodes located in each of the at least two liquid crystal alignment regions, wherein the branch electrodes are parallel to each other and are connected to the main electrode; and a plurality of gaps formed between every two adjacent branch electrodes.

The present embodiment provides the pixel electrode structure. By the zigzag-shaped electrode strip of the pixel electrode structure, a junction electric field is formed in a liquid crystal cell to which the main electrode corresponds. The junction electric field may improve convergence and collimation of light; therefore, black lines may be stabilized, widths of the black lines may be reduced, and light transmittance through display panels may be increased. Furthermore, by a disposing way of the zigzag-shaped electrode strip, black lines may be stabilized, and widths of the main electrode may be reduced, thereby further reducing widths of the black lines appearing on a location corresponding to the main electrode and increasing light transmittance through display panels.

Specifically, the pixel electrode structure provided by the present disclosure are described as follows according to specific embodiments.

In one embodiment, as shown in FIG. 2, FIG. 2 is the schematic plan view showing a first pixel electrode pixel structure provided by the present embodiment. The pixel electrode structure includes a first main electrode 201 extending along horizontal direction and a second main electrode 202 extending along vertical direction. The first main electrode 201 and the second main electrode 202 are located on a center of a pixel electrode and cross each other to form a cross construction. The pixel electrode is divided into four liquid crystal alignment regions with equal size by the first main electrode 201 and the second main electrode 202. A plurality of branch electrodes 203 are disposed in each of the liquid crystal alignment regions, ends of the branch electrodes 203 are connected to the first main electrode 201 or the second main electrode 202, and the other ends of the branch electrodes 203 extend along a direction away from the first main electrode 201 or the second main electrode 202. In each of the liquid crystal alignment regions, the branch electrodes 203 are parallel to each other, and a plurality of gaps 204 are formed between every two adjacent branch electrodes 203.

A width of the first main electrode 201 and a width of the second main electrode 202 may be even or uneven, that is, the width of the first main electrode 201 and the width of the second main electrode 202 may be same or different. Preferably, as shown in FIG. 2, the width of the first main electrode 201 and the width of the second main electrode 202 are even, and the width of the first main electrode 201 and the width of the second main electrode 202 are same.

The widths of the above two main electrodes range from 2 μm to 6 μm and are not less than widths of the branch electrodes 203. The greater the widths of the above two main electrodes, the more stable the black lines appearing on a location corresponding to the above two main electrodes. The less the widths of the above two main electrodes, the more convergent the black lines appearing on the location corresponding to the above two main electrodes, and the less the widths of the black lines appearing on the location corresponding to the above two main electrodes. As a result, the widths of the above two main electrodes should be as narrow as possible as long as stability of the black lines appearing on the location corresponding to the above two main electrodes can be ensured.

In each of the liquid crystal alignment regions, widths of different branch electrodes 203 may be same or different, and widths of different portions of a single branch electrode 203 may be same or different. Specifically, the widths of different branch electrodes 203 and the widths of different portions of a single branch electrode 203 may be decided by an electric field distribution, but are not limited here. The widths of the branch electrodes 203 range from 2 μm to 3.5 μm. Preferably, as shown in FIG. 2, the widths of different portions of a single branch electrode 203 are same, and the widths of different branch electrodes 203 are same as well.

Likewise, widths of different gaps 204 may be same or different, and widths of different portions of a single gap 204 may be same or different. Specifically, the widths of different gaps 204 and the widths of different portions of a single gap 204 may be decided by an electric field distribution, but are not limited here. The widths of the gaps 204 range from 1 μm to 4.5 μm. Preferably, as shown in FIG. 2, the widths of different portions of a single gap 204 are same, and the widths of different gaps 204 are same as well.

The first main electrode 201 and the second main electrode 202 are made of a plurality of main electrode segments which are sequentially connected, and lengths of the main electrode segments may be same or different. Preferably, as shown in FIG. 2, lengths of the main electrode segments of the first main electrode 201 are same, and lengths of the main electrode segments of the second main electrode 202 are same as well.

As shown in FIG. 3, the second main electrode 202 is made of a plurality of second main electrode segments 2021 and a plurality of second main electrode segments 2022 which are sequentially connected. An included angle α is formed between a second main electrode 2021 and a second main electrode segment 2022 which are adjacent to each other; therefore, the entire second main electrode 202 is a strip electrode with a zigzag shape. A plurality of first branch electrodes 2031 are connected to the second main electrode segments 2021, and a plurality of second branch electrodes 2032 are connected to the second main electrode segments 2022. Included angles between the first branch electrode 2031 and the second main electrode segments 2021 and included angles between the second branch electrode 2032 and the second main electrode segments 2022 are same as the included angle α ranging from 60° to 120°. Preferably, the included angle α is 90°.

In the present embodiment, each of the second main electrode segments 2021 only corresponds to one gap (first gap 2041). Similarly, each of the second main electrode segments 2022 only corresponds to one gap (second gap 2042). In other words, in the pixel electrode structure provided by the present embodiment, an orderly zigzag-shaped design is formed by one gap crossing a main electrode segment.

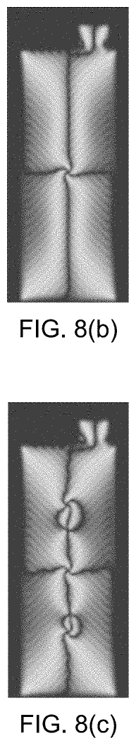

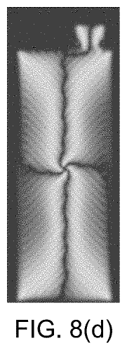

As shown in FIG. 8(b), FIG. 8(b) is a simulation diagram showing the first pixel electrode structure provided by the present embodiment. By the pixel electrode structure having the orderly zigzag shape formed by one gap crossing a main electrode segment, a crisscross junction electric field can be formed at a center of a pixel electrode. The junction electric field converges a crisscross black line at the center of the pixel electrode and reduces a width of the crisscross black line at the center of the pixel electrode, which is beneficial for improving light transmittance through a display panel. Compared to a crisscross black line in FIG. 8(a), a crisscross black line in FIG. 8(b) is apparently more stable. Therefore, stability of a display panel may be improved.

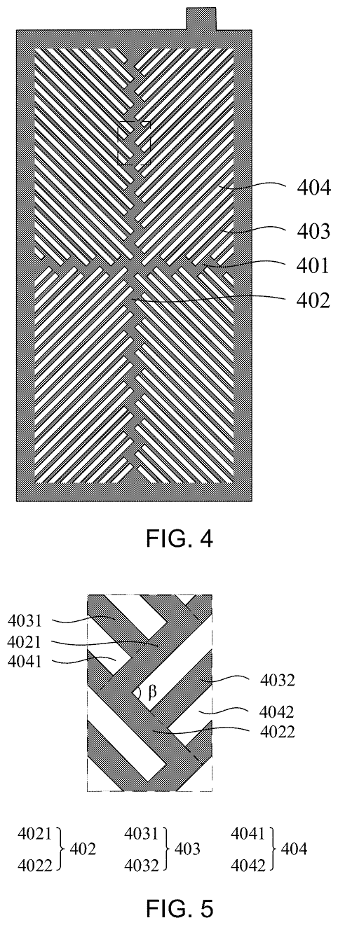

In one embodiment, as shown in FIG. 4, FIG. 4 is a schematic plan view showing a second pixel electrode structure provided by the embodiment of the present disclosure. The pixel electrode structure includes a third main electrode 401 extending along horizontal direction and a fourth main electrode 402 extending along vertical direction. The first main electrode 401 and the second main electrode 402 are located on a center of a pixel electrode and cross each other to form a cross construction. The pixel electrode is divided into four liquid crystal alignment regions with equal size by the third main electrode 401 and the fourth main electrode 402. A plurality of branch electrodes 403 are disposed in each of the liquid crystal alignment regions, ends of the branch electrodes 403 are connected to the third main electrode 401 or the fourth main electrode 402, and the other ends of the branch electrodes 403 extends along a direction away from the third main electrode 401 or the fourth main electrode 402. In each of the liquid crystal alignment regions, the branch electrodes 403 are parallel to each other, and a plurality of gaps 404 are formed between every two adjacent branch electrodes 403.

A width of the third main electrode 401 and a width of the fourth main electrode 402 may be even or uneven, that is, the width of the third main electrode 401 and the width of the fourth main electrode 402 may be same or different. Preferably, as shown in FIG. 4, the width of the third main electrode 401 and the width of the fourth main electrode 402 are even, and the width of the third main electrode 401 and the width of the fourth main electrode 402 are same.

The widths of the above two main electrodes range from 2 μm to 6 μm and are not less than widths of the branch electrodes 403. The greater the widths of the above two main electrodes, the more stable the black lines appearing on a location corresponding to the above two main electrodes. The less the widths of the above two main electrodes, the more convergent the black lines appearing on the location corresponding to the above two main electrodes, and the less the widths of the black lines appearing on the location corresponding to the above two main electrodes. As a result, the widths of the above two main electrodes should be as narrow as possible as long as stability of the black lines appearing on the location corresponding to the above two main electrodes can be ensured.

In each of the liquid crystal alignment regions, widths of different branch electrodes 403 may be same or different, and widths of different portions of a single branch electrode 403 may be same or different. Specifically, the widths of different branch electrodes 403 and the widths of different portions of a single branch electrode 403 may be decided by an electric field distribution, but are not limited here. The widths of the branch electrodes 403 range from 2 μm to 3.5 μm. Preferably, as shown in FIG. 4, the widths of different portions of a single branch electrode 403 are same, and the widths of different branch electrodes 403 are same as well.

Likewise, widths of different gaps 404 may be same or different, and widths of different portions of a single gap 404 may be same or different. Specifically, the widths of different gaps 404 and the widths of different portions of a single gap 404 may be decided by an electric field distribution, but are not limited here. The widths of the gaps 404 range from 1 μm to 4.5 μm. Preferably, as shown in FIG. 4, the widths of different portions of a single gap 404 are same, and the widths of different gaps 404 are same as well.

The third main electrode 401 and the fourth main electrode 402 are made of a plurality of main electrode segments which are sequentially connected, and lengths of the main electrode segments may be same or different. Preferably, as shown in FIG. 4, lengths of the main electrode segments of the third main electrode 401 are same, and lengths of the main electrode segments of the fourth main electrode 402 are same as well.

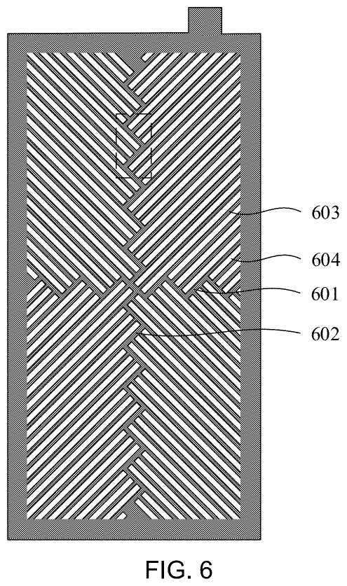

As shown in FIG. 5, the fourth main electrode 402 is made of a plurality of fourth main electrode segments 4021 and a plurality of fourth main electrode segments 4022 which are sequentially connected. An included angle β is formed between a fourth main electrode 4021 and a fourth main electrode segment 4022 which are adjacent to each other; therefore, the entire fourth main electrode 402 is a strip electrode with a zigzag shape. A plurality of third branch electrodes 4031 are connected to the fourth main electrode segments 4021, and a plurality of the fourth branch electrodes 4032 are connected to the fourth main electrode segments 4022. Included angles between the third branch electrodes 4031 and the fourth main electrode segments 4021 and included angles between the fourth branch electrodes 4032 and the fourth main electrode segments 4022 are same as the included angle β ranging from 60° to 120°. Preferably, the included angle β is 90°.

In the present embodiment, each of the fourth main electrode segments 4021 corresponds to two gaps (two third gaps 4041). Similarly, each of the fourth main electrode segments 4022 corresponds to two gaps (two fourth gaps 4042). In other words, in the pixel electrode structure provided by the present embodiment, an orderly zigzag-shaped design is formed by two gaps crossing a main electrode segment.

As shown in FIG. 8(c), FIG. 8(c) is a simulation diagram showing the second pixel electrode structure provided by the present embodiment. By the pixel electrode structure having the orderly zigzag shape formed by two gaps crossing a main electrode segment, a crisscross junction electric field can be formed at a center of a pixel electrode. The junction electric field converges a crisscross black line at the center of the pixel electrode and reduces a width of the crisscross black line at the center of the pixel electrode, which is beneficial for improving light transmittance through a display panel. Compared to a crisscross black line in FIG. 8(a), a crisscross black line in FIG. 8(b) is apparently more stable. Therefore, light transmittance through a display panel may be increased.

Compared to the pixel electrode structure having the orderly zigzag shape formed by one gap crossing a main electrode segment, under a condition that other parameters are same, in the pixel structure provided by the present disclosure, lengths of the main electrode segments are increased so that a length of the entire main electrode is increased, and a length of a crisscross black line at a center of a pixel electrode is increased as well.

In one embodiment, as shown in FIG. 6, FIG. 6 is a schematic plan view showing a third pixel electrode structure provided by the embodiment of the present disclosure. The pixel electrode structure includes a fifth main electrode 601 extending along horizontal direction and a sixth main electrode 602 extending along vertical direction. The fifth main electrode 601 and the sixth main electrode 602 are located on a center of a pixel electrode and cross each other to form a cross construction. The pixel electrode is divided into four liquid crystal alignment regions with equal size by the fifth main electrode 601 and the sixth main electrode 602. A plurality of branch electrodes 603 are disposed in each of the liquid crystal alignment regions, an end of the branch electrodes 603 is connected to the fifth main electrode 601 or the sixth main electrode 602, and the other end of the branch electrodes 603 extends along a direction away from the fifth main electrode 601 or the sixth main electrode 602. In each of the liquid crystal alignment regions, the branch electrodes 603 are parallel to each other, and a plurality of gaps 604 are formed between every two adjacent branch electrodes 603.

A width of the fifth main electrode 601 and a width of the sixth main electrode 602 may be even or uneven, that is, the width of the fifth main electrode 601 and the width of the sixth main electrode 602 may be same or different. Preferably, as shown in FIG. 6, the width of the fifth main electrode 601 and the width of the sixth main electrode 602 are even, and the width of the fifth main electrode 601 and the width of the sixth main electrode 602 are same.

The widths of the above two main electrodes range from 2 μm to 6 μm and are not less than widths of the branch electrodes 603. The greater the widths of the above two main electrodes, the more stable the black lines appearing on a location corresponding to the above two main electrodes. The less the widths of the above two main electrodes, the more convergent the black lines appearing on the location corresponding to the above two main electrodes, and the less the widths of the black lines appearing on the location corresponding to the above two main electrodes. As a result, the widths of the above two main electrodes should be as narrow as possible as long as stability of the black lines appearing on the location corresponding to the above two main electrodes can be ensured.

In each of the liquid crystal alignment regions, widths of different branch electrodes 603 may be same or different, and widths of different portions of a single branch electrode 603 may be same or different. Specifically, the widths of different branch electrodes 603 and the widths of different portions of a single branch electrode 603 may be decided by an electric field distribution, but are not limited here. The widths of the branch electrodes 403 range from 2 μm to 3.5 μm. Preferably, as shown in FIG. 6, the widths of different portions of a single branch electrode 603 are same, and the widths of different branch electrodes 603 are same as well.

Likewise, widths of different gaps 604 may be same or different, and widths of different portions of a single gap 604 may be same or different. Specifically, the widths of different gaps 604 and the widths of different portions of a single gap 604 may be decided by an electric field distribution, but are not limited here. The widths of the gaps 604 range from 1 μm to 4.5 μm. Preferably, as shown in FIG. 6, the widths of different portions of a single gap 604 are same, and the widths of different gaps 604 are same as well.

The fifth main electrode 601 and the sixth main electrode 602 are made of a plurality of main electrode segments which are sequentially connected, and lengths of the main electrode segments may be same or different. Preferably, as shown in FIG. 6, lengths of the main electrode segments of the fifth main electrode 601 are same, and lengths of the main electrode segments of the sixth main electrode 602 are same as well.

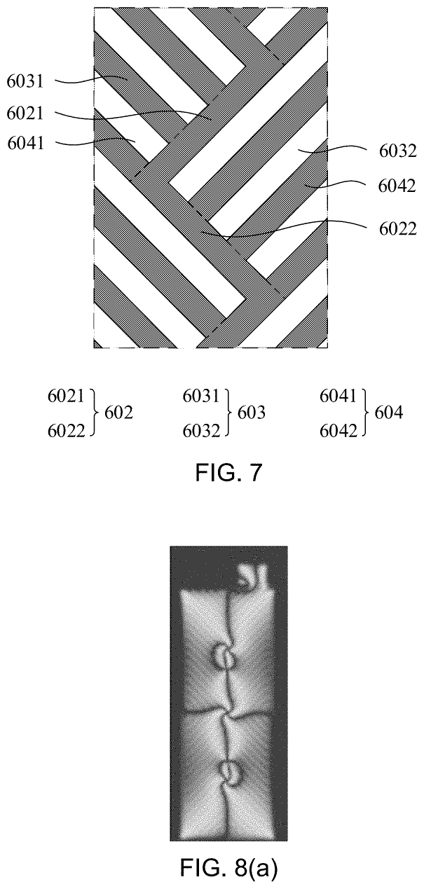

As shown in FIG. 7, the sixth main electrode 602 is made of a plurality of sixth main electrode segments 6021 and a plurality of sixth main electrode segments 6022 which are sequentially connected. An included angle γ is formed between a sixth main electrode 6021 and a sixth main electrode segment 6022 which are adjacent to each other; therefore, the entire sixth main electrode 602 is a strip electrode with a zigzag shape. A plurality of fifth branch electrodes 6031 are connected to the sixth main electrode segments 6021, and a plurality of the sixth branch electrodes 6032 are connected to the sixth main electrode segments 6022. Included angles between the fifth branch electrodes 6031 and the sixth main electrode segments 6021 and included angles between the sixth branch electrodes 6032 and the sixth main electrode segments 6022 are same as the included angle γ ranging from 60° to 120°. Preferably, the included angle γ is 90°.

In the present embodiment, each of the sixth branch main electrode segments 6021 corresponds to three gaps (three third gaps 4041). Similarly, each of the fourth branch main electrode segments 4022 corresponds to three gaps (three fourth gaps 4042). In other words, in the pixel electrode structure provided by the present embodiment, an orderly zigzag-shaped design is formed by three gaps crossing a main electrode segment.

As shown in FIG. 8(d), FIG. 8(d) is a simulation diagram showing the pixel electrode structure provided by the present embodiment. By the pixel electrode structure having the orderly zigzag shape formed by three gaps crossing a main electrode segment, a crisscross junction electric field can be formed at a center of a pixel electrode. The junction electric field converges a crisscross black line at the center of the pixel electrode and reduces a width of the crisscross black line at the center of the pixel electrode, which is beneficial for improving light transmittance through a display panel. Compared to a crisscross black line in FIG. 8(a), a crisscross black line in FIG. 8(b) is apparently more stable. Therefore, light transmittance through a display panel may be increased.

Compared to the pixel electrode structure having the orderly zigzag shape formed by three gaps crossing a main electrode segment, under a condition that other parameters are same, in the pixel structure provided by the present disclosure, lengths of the main electrode segments are further increased so that a length of the entire main electrode is further increased, and a length of a crisscross black line at a center of a pixel electrode is further increased as well. An overly long black line is not beneficial for improving light transmittance. On the other hand, a corner between long main electrode segments is not beneficial for stabling a black line at a center of a pixel electrode.

In other embodiments, the included angle between two adjacent main electrode segments may be any angles ranging from 60° to 120° in addition to 90°, and a working principle is similar to and may be referred to the above embodiments. The included angle between two adjacent main electrode segments is not limited here.

In other embodiments, a zigzag-shaped main electrode having the designs of one gap crossing a main electrode segment, two gaps crossing a main electrode segment, and three gaps crossing a main electrode segment may be randomly combined in a single pixel electrode structure, and a working principle is similar to and may be referred to the above embodiments. The design of a zigzag-shaped main electrode is not limited here.

A pixel electrode provided by the present disclosure may have a four-domain structure, an eight-domain structure, or a multiple-domain structure, whereas structures of the pixel electrode are not limited to the present disclosure.

Meanwhile, the present disclosure further provides a liquid crystal display (LCD) panel, including a pixel electrode structure having a plurality of arrays disposed thereon. The pixel electrode includes: a main electrode located on a center of a pixel electrode, wherein the pixel electrode is divided into at least two liquid crystal alignment regions by the main electrode, and the main electrode is an electrode strip with a zigzag shape; a plurality of branch electrodes located in each of the at least two liquid crystal alignment regions, wherein the branch electrodes are parallel to each other and are connected to the main electrode; and a plurality of gaps formed between every two adjacent branch electrodes.

The present disclosure provides an LCD panel including a pixel electrode structure. The pixel electrode structure includes a main electrode located on a center of a pixel electrode, wherein the pixel electrode is divided into at least two liquid crystal alignment regions by the main electrode, and the main electrode is an electrode strip with a zigzag shape; a plurality of branch electrodes located in the at least two liquid crystal alignment regions, wherein the branch electrodes are parallel to each other and are connected to the main electrode; and a plurality of gaps formed between two adjacent branch electrodes. By the zigzag-shaped electrode strip of the pixel electrode structure, a junction electric field is formed in a liquid crystal cell to which the main electrode corresponds. The junction electric field may improve convergence and collimation of light; therefore, black lines may be stabilized, widths of the black lines may be reduced, and light transmittance through display panels may be increased. Furthermore, by a disposing way of the zigzag-shaped electrode strip, black lines may be stabilized, and widths of the main electrode may be reduced, thereby further reducing widths of the black lines appearing on a location corresponding to the main electrode and increasing light transmittance through display panels.

In one embodiment, a width of the main electrode ranges from 2 μm to 6 μm.

In one embodiment, a width of the main electrode ranges from 2 μm to 6 μm.

In one embodiment, the main electrode is made of a plurality of main electrode segments which are connected to each other, and an included angle between each two adjacent main electrode segments ranges from 60° to 120°.

In one embodiment, an included angle between the branch electrodes and the main electrode connected thereto and the included angle between each two adjacent main electrode segments are same.

In one embodiment, the included angle between each two adjacent main electrode segments is 90°.

In one embodiment, widths of the main electrode segments are same.

In one embodiment, each of the main electrode segments corresponds to one of the gaps.

In one embodiment, each of the main electrode segments corresponds to and is perpendicular to two of the gaps.

In one embodiment, each of the main electrode segments corresponds to and is perpendicular to three of the gaps.

According to the above embodiments, the present disclosure provides a pixel electrode structure and an LCD panel. The pixel electrode structure includes a main electrode located on a center of a pixel electrode, wherein the pixel electrode is divided into at least two liquid crystal alignment regions by the main electrode, and the main electrode is an electrode strip with a zigzag shape; a plurality of branch electrodes located in the at least two liquid crystal alignment regions, wherein the branch electrodes are parallel to each other and are connected to the main electrode; and a plurality of gaps formed between two adjacent branch electrodes. By the zigzag-shaped electrode strip of the pixel electrode structure, a junction electric field is formed in a liquid crystal cell to which the main electrode corresponds. The junction electric field may improve convergence and collimation of light; therefore, black lines may be stabilized, widths of the black lines may be reduced, and light transmittance through display panels may be increased. Furthermore, by a disposing way of the zigzag-shaped electrode strip, black lines may be stabilized, and widths of the main electrode may be reduced, thereby further reducing widths of the black lines appearing on a location corresponding to the main electrode and increasing light transmittance through display panels.

To sum up, the present disclosure has been described with a preferred embodiment thereof. The preferred embodiment is not intended to limit the present disclosure, and it is understood that many changes and modifications to the described embodiment can be carried out without departing from the scope and the spirit of the disclosure that is intended to be limited only by the appended claims.

1. A pixel electrode structure, comprising:
a main electrode located on a center of a pixel electrode, wherein the pixel electrode is divided into at least two liquid crystal alignment regions by the main electrode, and the main electrode is an electrode strip with a zigzag shape;
a plurality of branch electrodes located in each of the at least two liquid crystal alignment regions, wherein the branch electrodes are parallel to each other and are connected to the main electrode; and
a plurality of gaps formed between every two adjacent branch electrodes.

2. The pixel electrode structure of claim 1, wherein a width of the main electrode ranges from 2 μm to 6 μm.

3. The pixel electrode structure of claim 1, wherein widths of the branch electrodes range from 2 μm to 3.5 μm.

4. The pixel electrode structure of claim 1, wherein the main electrode is made of a plurality of main electrode segments which are connected to each other, and an included angle between each two adjacent main electrode segments ranges from 60° to 120°.

5. The pixel electrode structure of claim 4, wherein an included angle between the branch electrodes and the main electrode segments connected thereto and the included angle between each two adjacent main electrode segments are same.

6. The pixel electrode structure of claim 5, wherein the included angle between each two adjacent main electrode segments is 90°.

7. The pixel electrode structure of claim 6, wherein lengths of the main electrode segments are same.

8. The pixel electrode structure of claim 7, wherein each of the main electrode segments corresponds to one of the gaps.

9. The pixel electrode structure of claim 7, wherein each of the main electrode segments corresponds to and is perpendicular to two of the gaps.

10. The pixel electrode structure of claim 7, wherein each of the main electrode segments corresponds to and is perpendicular to three of the gaps.

11. A liquid crystal display (LCD) panel, comprising a pixel electrode structure comprising:
a main electrode located on a center of a pixel electrode, wherein the pixel electrode is divided into at least two liquid crystal alignment regions by the main electrode, and the main electrode is an electrode strip with a zigzag shape.
a plurality of branch electrodes located in each of the at least two liquid crystal alignment regions, wherein the branch electrodes are parallel to each other and are connected to the main electrode; and
a plurality of gaps formed between every two adjacent branch electrodes.

12. The LCD panel of claim 11, wherein a width of the main electrode ranges from 2 μm to 6 μm.

13. The LCD panel of claim 11, wherein widths of the branch electrodes range from 2 μm to 3.5 μm.

14. The LCD panel of claim 11, wherein the main electrode is made of a plurality of main electrode segments which are connected to each other, and an included angle between each two adjacent main electrode segments ranges from 60° to 120°.

15. The LCD panel of claim 14, wherein an included angle between the branch electrodes and the main electrode segments connected thereto and the included angle between each two adjacent main electrode segments are same.

16. The LCD panel of claim 15, wherein the included angle between each two adjacent main electrode segments is 90°.

17. The LCD panel of claim 16, wherein lengths of the main electrode segments are same.

18. The LCD panel of claim 17, wherein each of the main electrode segments corresponds to one of the gaps.

19. The LCD panel of claim 17, wherein each of the main electrode segments corresponds to and is perpendicular to two of the gaps.

20. The LCD panel of claim 17, wherein each of the main electrode segments corresponds to and is perpendicular to three of the gaps.
